(19) United States
(12) Patent Application Publication
(10) Pub. No.: US 2025/0233945 A1
(43) Pub. Date: Jul. 17, 2025

(54) INSPECTION APPARATUS, INSPECTION SYSTEM, AND METHOD OF CONTROLLING THE INSPECTION APPARATUS

(71) Applicant: CANON KABUSHIKI KAISHA, Tokyo (JP)

(72) Inventor: ASAKO SUGAHARA, Chiba (JP)

(21) Appl. No.: 19/013,617

(22) Filed: Jan. 8, 2025

(30) Foreign Application Priority Data
Jan. 17, 2024 (JP) 2024-005560

(51) Int. Cl. H04N 1/00

(52) U.S. Cl. CPC H04N 1/00005; H04N 1/00045; H04N 1/00076; H04N 1/00087; H04N 1/00129; H04N 2201/0094

(57) ABSTRACT

An inspection apparatus obtains a scanned image generated by reading a printed material, sets an inspection level for determining whether the printed material passes or fails in a primary inspection, compares the scanned image with a reference image and inspects the printed material based on the set inspection level, and displays a screen showing an inspection result of the primary inspection on a display. The screen includes the inspection result of the primary inspection for the printed material at the set inspection level, an object that is associated with the inspection result and indicates a target for inputting a result of a secondary inspection, and a pass level at which an inspection result of the printed material is that the printed material passes the primary inspection.

### BACKGROUND

### Field of the Disclosure

One or more features of the present disclosure relate to one or more embodiments of an inspection apparatus, an inspection system, and a method of controlling the inspection apparatus.

### Description of the Related Art

Conventionally, inspection for checking whether printed material has been printed correctly has been done manually, but in recent years, inspection apparatuses have been used which, as post-processing for a print processing, automatically inspect printed material printed by a printing apparatus. With this type of inspection apparatus, an inspection level is set in advance, and based on that inspection level, it is determined whether an image obtained by reading the printed material is normal (OK) or not normal (NG). This is called primary inspection. Furthermore, visual inspection is performed by an operator for the purpose of sampling inspection of acceptable products that have been determined as normal and re-inspection of unacceptable products that have been determined as abnormal. This is called secondary inspection.

Japanese Patent Laid-Open No. 2021-56466 describes a method in which each page is given a score during inspection, and pages that are determined as passing but have low scores are presented to the operator as targets for the secondary inspection. Furthermore, since having too many targets for the secondary inspection places a burden on the operator, it is described that the operator can designate the number or percentage of targets for the secondary inspection.

However, in the method described in Japanese Patent Laid-Open No. 2021-56466, the locations that are secondary inspection targets on a page that has been determined as passing are selected based on inspection target information regarding manual secondary inspection targets, which has been set in advance by the user, and the locations are presented to the operator. For this reason, operators must rely solely on visual evaluation to determine whether or not a page that is a target for the secondary inspection passes, which makes secondary inspection time-consuming. There is also the issue of variation in the determination results of the secondary inspection.

### SUMMARY

One or more aspects of embodiments of the present disclosure eliminate the above-mentioned issues with conventional technology.

At least one feature of embodiments of the present disclosure is to provide a technique for enabling checking of an inspection item that is a target for or of a secondary inspection and an inspection level at which an inspection result relating to the inspection item is determined as normal, on a screen that displays results of a primary inspection. This makes it possible to reduce the amount of time required for the secondary inspection and to reduce variation in the determination results of the secondary inspection.

According to one or more aspects that may be used in one or more embodiments of the present disclosure, there is provided an inspection apparatus configured to inspect printed material, where the inspection apparatus may include: one or more controllers including one or more processors in communication with one or more memories, the one or more controllers configured or operating to: obtain a scanned image generated by reading the printed material; set an inspection level for determining whether the printed material passes or fails in a primary inspection; compare the scanned image with a reference image and inspect the printed material based on the set inspection level; and display a screen showing an inspection result of the primary inspection on a display, wherein the screen includes the inspection result of the primary inspection for the printed material at the set inspection level, an object that is associated with the inspection result and indicates a target for or of inputting a result of a secondary inspection, and a pass level at which an inspection result of the printed material is that the printed material passes the primary inspection.

According to one or more aspects that may be used in one or more embodiments of the present disclosure, there is provided a method of controlling an inspection apparatus configured to inspect printed material, where the method may include: obtaining a scanned image generated by reading the printed material; setting an inspection level for determining whether the printed material passes or fails in a primary inspection; comparing the scanned image with a reference image and inspecting the printed material based on the set inspection level; and displaying, on a display, a screen showing an inspection result of the primary inspection obtained by inspecting the printed material, wherein the screen includes the inspection result of the primary inspection for the printed material at the set inspection level, an object that is associated with the inspection result and indicates a target for or of inputting a result of a secondary inspection, and a pass level at which an inspection result of the printed material is that the printed material passes the primary the inspection.

According to other aspects of the present disclosure, one or more additional inspection apparatuses and/or inspection systems and one or more additional methods for inspection apparatuses or systems are discussed herein.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate one or more non-exhaustive, non-limiting embodiments of the present disclosure and, together with the description, serve to explain one or more features and/or one or more principles of the present disclosure.

FIG. 1 is a diagram for describing a configuration of an inspection system including an inspection apparatus according to one or more embodiments of the present disclosure.

FIG. 2 is a block diagram for describing a hardware configuration of an image forming apparatus that may be used in one or more embodiments of the present disclosure.

FIG. 3 is a block diagram for describing a hardware configuration of the inspection apparatus according to one or more embodiments of the present disclosure.

FIG. 4 is a flowchart for describing inspection processing performed by the inspection apparatus according to one or more embodiments of the present disclosure.

FIG. 5 depicts a view showing an example of a job management screen displayed on a UI unit of the inspection apparatus according to one or more embodiments of the present disclosure.

FIG. 6 depicts a view showing an example of an inspection setting screen for performing inspection setting, displayed on the UI unit of the inspection apparatus according to one or more embodiments of the present disclosure.

FIG. 7 is a flowchart for describing inspection setting processing in step S404 of FIG. 4 that may be used in one or more embodiments of the present disclosure.

FIGS. 8A to 8C are diagrams illustrating details of an inspection result of a region 1008 that may be displayed (see e.g., in FIG. 10) on the UI unit of the inspection apparatus according to one or more embodiments of the present disclosure.

FIGS. 9A to 9C depict views respectively showing examples of input screens for secondary inspection results that may be displayed on the UI unit of the inspection apparatus according to one or more embodiments of the present disclosure.

FIG. 10 depicts a view showing an example of an inspection screen displayed on the UI unit of the inspection apparatus according to one or more embodiments of the present disclosure.

FIG. 11 is a flowchart for describing secondary inspection processing that may be performed (see e.g., in step S404 of FIG. 4) by an inspection apparatus according to one or more embodiments of the present disclosure.

FIGS. 12A and 12B depict views respectively showing examples of screens for instructing inspection or re-inspection through recovery printing, which may be displayed on a UI unit of the inspection apparatus according to one or more embodiments of the present disclosure.

### DESCRIPTION OF THE EMBODIMENTS

One or more embodiments and/or features of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Configurations in the following embodiments are merely examples, and the present technique(s)/feature(s) of the present disclosure is/are not limited to the illustrated configurations. Further, in the accompanying drawings, the same or similar configurations are assigned the same reference numerals, and redundant descriptions are omitted. Note that in the following description, an image forming apparatus is also called a multi-function peripheral (MFP) in some cases.

Details of one or more embodiments of the present disclosure follow below:

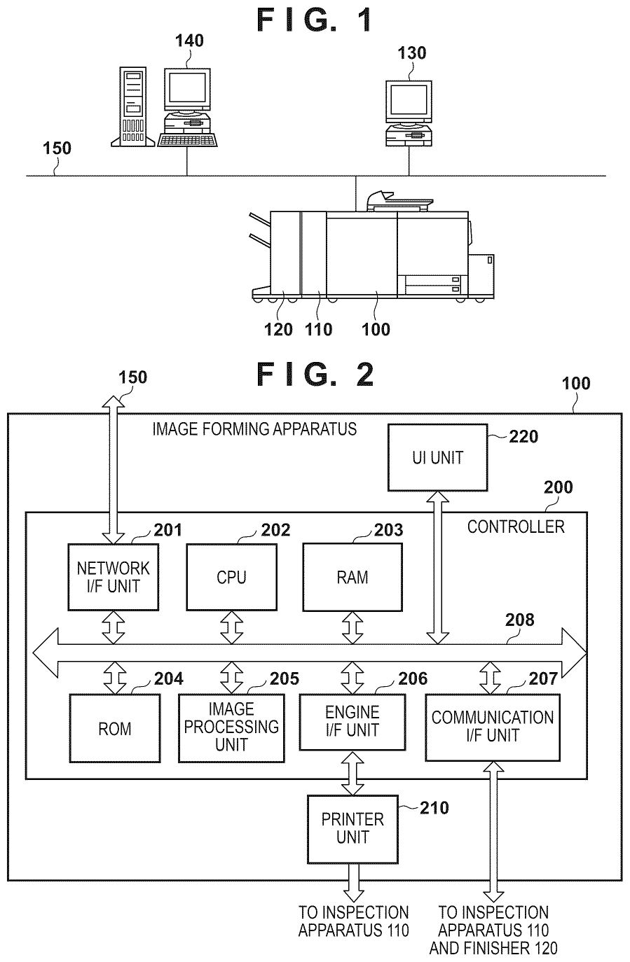

FIG. 1 is a diagram for describing a configuration of an inspection system including an inspection apparatus according to one or more embodiments of the present disclosure.

One or more embodiments of an inspection system may include an image forming apparatus 100, an inspection apparatus 110 and a finisher 120 built into the image forming apparatus 100, a client PC 130, and a print server 140. The image forming apparatus 100, the client PC 130, and the print server 140 may be connected to, or in communication with, each other via a network 150.

The image forming apparatus 100 operates to perform printing based on various types of input data, such as images and documents sent from the client PC 130 or the print server 140, and to output printed material. Note that in at least one embodiment, the image forming apparatus 100 is described, but there is no limitation to this, and any printing apparatus that prints on a recording medium such as a sheet may be used. For example, an apparatus for printing on metal may also be used.

The inspection apparatus 110 inspects the printed material sequentially transported from the image forming apparatus 100 for defects. Here, a defect is something that reduces the quality of the printed material, and includes, for example, stains caused by color material adhering to unintended locations during printing, and color omissions caused by insufficient color material adhering to intended locations.

Furthermore, the inspection apparatus 110 may operate to inspect a variable region such as a character string, a one-dimensional code such as a barcode, or a two-dimensional barcode in variable printing including the variable region. For example, a data legibility inspection for checking whether or not a character string or a barcode is readable, a data collating inspection for comparing the result of reading the character string or the barcode with correct answer data, and the like may be performed. That is, the inspection apparatus 110 may perform a printed image inspection for detecting defects in a pattern portion of the printed material, and a data inspection including a data legibility inspection and a data collating inspection. Note that it is not necessary for the inspection apparatus 110 to have an inspection processing unit inside it that performs a printed image inspection, a data legibility inspection, and a data collating inspection, and such inspections may be performed, for example, by an information processing apparatus (not shown) serving as an inspection PC that is connected to (directly or indirectly) the inspection apparatus 110 in a communication-enabled manner. Also, although it is described in one or more embodiments that the inspection apparatus 110 built into the image forming apparatus 100 operates to perform the inspection processing, there is no limitation thereto. For example, in one or more embodiments, an inspection PC dedicated to inspection processing may be connected to an inspection apparatus that mainly performs image capture via a communication unit, and upon receiving images captured by the inspection apparatus, the inspection PC may perform inspection processing based on an inspection setting received by the inspection PC.

The finisher 120 operates to receive the printed material inspected by the inspection apparatus 110, switch the discharge destination based on the results of the inspection performed by the inspection apparatus 110, and discharge the printed material after executing post-processing (book binding, stapling, etc.) as necessary or as instructed.

The image forming apparatus 100 may be connected to the client PC 130 and the print server 140 via the network 150, and may be further connected to the inspection apparatus 110 and the finisher 120 via communication cables. Also, the inspection apparatus 110 may be connected to the image forming apparatus 100 as well as the finisher 120 via communication cables. One or more embodiments will be described using, as an example, an in-line inspection machine that performs all processes including image formation, inspection, post-processing, and paper discharging, but this is not intended to limit the aspects or features of the present disclosure (and other configurations may be used in one or more embodiments of the present disclosure).

FIG. 2 is a block diagram for describing a hardware configuration of an image forming apparatus 100 according to one or more embodiments.

A controller 200 receives image data and document data via the network 150 and converts the received image data and document data into print data. A printer unit 210 generates printed material by printing images and documents on a recording medium (paper, sheet) based on print data. A user interface (UI) unit 220 displays a screen (e.g., on a display connected to or in communication with the UI unit 220, on a display that operates to display one or more User Interfaces to the operator), etc.) and receives instructions from an operator to the image forming apparatus 100, such as selection of paper information. In one or more embodiments, the image forming apparatus 100 includes the controller 200, the printer unit 210, and the UI unit 220 described above. Note that when the controller 200 receives input of image data or document data that has been converted into print data from the print server 140, processing for converting the image data or document data into print data by the controller 200 is not required.

Next, the configuration of the controller 200 that may be used in one or more embodiments will be described. A network interface (I/F) unit 201 transmits and receives data to and from the client PC 130 and the print server 140 via the network 150. A CPU 202 controls the entire image forming apparatus 100. A RAM 203 functions as a deploying area for the programs executed by the CPU 202 and as a work area when the CPU 202 executes various commands. A ROM 204 stores program data executed by the CPU 202 at startup, setting data for the controller 200, and the like. An image processing unit 205 performs raster image processing (RIP) processing for converting image data and document data received from the network 150 into print data. Note that in one or more embodiments, the RIP processing does not necessarily need to be performed by the image processing unit 205, and may be performed by an information processing apparatus such as the print server 140 (or another information processing apparatus) connected to the image forming apparatus 100, for example in a communication-enabled manner. An engine interface (I/F) unit 206 transmits print data to the printer unit 210. A communication I/F unit 207 communicates with the inspection apparatus 110 and the finisher 120. An internal bus (system bus) 208 connects the CPU 202 to each of the above-mentioned units of the controller 200, and the internal bus 208 operates to connect the CPU 202 to other/external units (e.g., via the network interface unit 201, via the network 150, via the engine interface unit 206, via the communication interface unit 207, etc.).

Image data and document data created on the client PC 130 or the print server 140 on the network 150 is transmitted as page description language (PDL) data to the image forming apparatus 100 via a network (e.g., a Local Area Network). Incidentally, a print job for an image, document, or the like may be transmitted to an information processing apparatus (not shown) via a network and managed by the information processing apparatus. The print job may then be transmitted from the information processing apparatus to the image forming apparatus 100 via the network 150, and the image forming apparatus 100 may perform processing for printing on paper.

The PDL data transmitted in this way to the image forming apparatus 100 is stored in the RAM 203 via the network I/F unit 201. Also, a print instruction issued by the operator via the UI unit 220 is stored in the RAM 203 via the internal bus 208. The print instruction issued by the operator includes, for example, the selection of the paper type and the like.

The image processing unit 205 obtains the PDL data stored in the RAM 203 and performs image processing for converting the PDL data into print data. The image processing for converting the PDL data into print data includes, for example, processing for rasterizing the PDL data to convert it into multi-value bitmap data, and for converting the multi-value bitmap data into binary bitmap data by performing screen processing or the like. The binary bitmap data obtained by the image processing unit 205 is sent to the printer unit 210 via the engine I/F unit 206.

In one or more embodiments, the printer unit 210 is a printer engine that forms images through electrophotography. The printer unit 210 prints the received binary bitmap data onto paper (a sheet) using color materials. The CPU 202 issues an instruction to the printer unit 210 based on the print instruction issued by the operator that is stored in the RAM 203. For example, when the operator issues an instruction to print on coated paper, the CPU 202 instructs the printer unit 210 to feed paper from a paper cassette (not shown) in which coated paper is stored in the image forming apparatus 100. In one or more embodiments, the various processes from receiving the above-mentioned PDL data to printing on paper are controlled by the CPU 202, whereby a full-color toner image is formed on the paper.

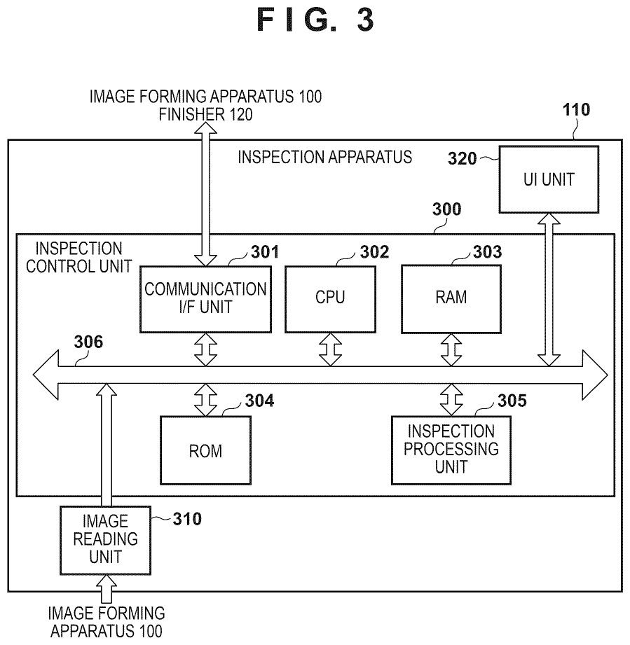

FIG. 3 is a block diagram for describing a hardware configuration of an inspection apparatus 110 according to one or more embodiments.

An inspection control unit 300 (also referred to as an “inspection controller”) performs overall control of the inspection apparatus 110 and controls the inspection processing for checking whether or not there is a defect in the printed material. An image reading unit 310 reads the printed material transported from the image forming apparatus 100. The image reading unit 310 generates a scanned image by reading the printed material. A UI unit 320 is a UI unit that allows an operator to perform setting of the inspection apparatus 110 and displays the inspection results and the like to the operator (e.g., in one or more embodiments, the UI unit 320 may be in communication with a display that operates to display one or more User Interfaces to the operator). Note that the setting of the inspection apparatus 110 performed by the operator here includes the inspection items, namely, which defects are to be inspected when inspecting the printed material. The inspection items include, for example, but are not limited to, designation of the shape of the defect, such as a circular defect (spot) or a linear defect (streak). In one or more embodiments, the inspection apparatus 110 may include the above-mentioned inspection control unit or inspection controller 300, the image reading unit 310, and the UI unit 320. Note that in one or more embodiments, the UI unit 320 includes, or is in communication with, a display or display unit that displays a screen, and a display control unit that controls the screen displayed on the display unit. In addition, display and reception of instructions regarding the setting of the inspection apparatus 110, the display of the inspection results, and the like performed by the UI unit 320 may be performed using an external apparatus such as the UI unit 220 of the image forming apparatus 100 described above, an inspection PC (not shown), or an information processing apparatus (not shown). Also, the UI unit 320 may have a touch panel function.

Next, the inspection control unit or the inspection controller 300 will be described. A communication I/F unit 301 transmits and receives data between the image forming apparatus 100, and the finisher 120. A CPU 302 performs overall control of the inspection apparatus 110. A RAM 303 functions as a deploying area for programs executed by the CPU 302 and as a work area when the CPU 302 executes various commands. A ROM 304 stores program data executed by the CPU 302 at startup, setting data for the inspection control unit 300, and the like. The ROM 304 also stores a correct answer CSV file, which will be described later. The inspection processing unit 305 inspects the printed material for defects. An internal bus 306 connects the CPU 302 to each of the above-mentioned units of the inspection controller 300, and the internal bus 306 operates to connect the CPU 302 to other/external units (e.g., via the communication interface unit 301, via the bus 208, via the network 150, etc.).

Next, an overview of the printed image inspection performed by the inspection apparatus 110 in one or more embodiments will be described.

The inspection apparatus 110 uses the image reading unit 310 to read the printed material transported from the image forming apparatus 100, and obtains a scanned image (read image) that is an inspection target. The scanned image that is the inspection target is stored in the RAM 303. Next, the inspection apparatus 110 uses the inspection processing unit 305 to compare the scanned image that is the inspection target with a reference image stored in advance in the RAM 303 as a correct answer image, and obtains a difference value. Specifically, feature points are extracted from the reference image and the scanned image, and the reference image and the scanned image are aligned based on the extracted feature points. If the difference between a pixel value (luminance value) of an inspection target pixel in the aligned scanned image and a pixel value (luminance value) of a comparison target pixel in the reference image is less than or equal to a threshold value, the inspection processing unit 305 determines that the inspection target pixel passes inspection. Note that the threshold value differs for each inspection level, which will be described later. Accordingly, this threshold value becomes smaller as the inspection level becomes higher (larger) (as the inspection becomes stricter), for example.

In one or more embodiments, in a case where the inspection of all of the inspection target pixels is complete, it is determined whether or not the total number of pixels that have been determined as failing is less than or equal to the passing threshold value, and it is determined whether or not the scanned image is normal. Here, if the total number of pixels determined as failing is less than or equal to the passing threshold value, the inspection processing unit 305 determines that the scanned image is normal. On the other hand, if the total number of pixels determined as failing exceeds the passing threshold value, the inspection processing unit 305 determines that the scanned image is not normal. In this case, the passing threshold value decreases as the inspection level becomes higher (larger), for example.

The results of this inspection are stored in the RAM 303, and for example, information regarding whether or not there is a defect in the printed material, the type of defect detected (spot or streak), position information of the defect when displayed on the UI unit 320, and the like are stored.

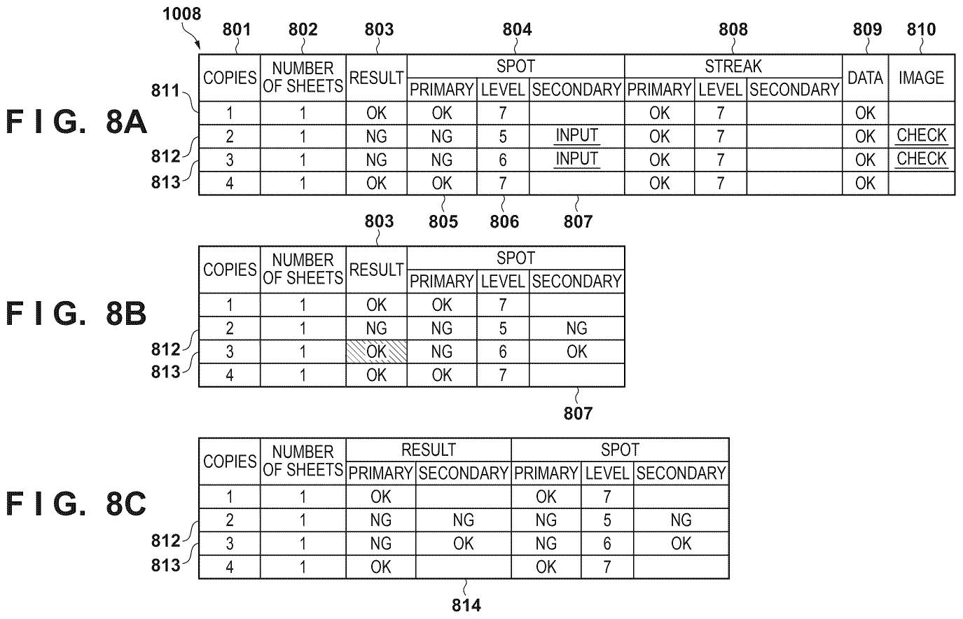

Note that if it is determined that the scanned image is not normal, the inspection processing unit 305 performs additional processing on the inspected scanned image. In this additional processing, the inspection level is changed to a level at which the scanned image is more likely to pass (the inspection level is lowered), and inspection is continued until it is determined that the scanned image passes. That is, the inspection level at which it is determined that the scanned image passes inspection is determined as the pass level. The pass level in this case is represented by, for example, a pass level 806 (levels 5 and 6) corresponding to a later-described primary inspection result 805 indicating that the inspection result of FIG. 8A is NG.

One method of implementing the additional processing is to retain the alignment information from when the reference image and the scanned image were initially aligned, re-extract the difference in pixel values (luminance values), and determine whether or not the inspection target pixel passes by performing determination using a threshold value corresponding to the new inspection level. The method of calculating the threshold value for determining passage or failure is not limited to the additional inspection processing. For example, the difference in pixel values (luminance values) extracted initially may be stored, and while the difference is read out, it may be determined whether or not the inspection target pixel passes the inspection by performing determination with a threshold value corresponding to a new inspection level. Alternatively, a method may be used in which the difference in pixel values (luminance values) is calculated by image processing to determine the threshold value. After all pixels have been inspected in this manner, it is determined whether or not the scanned image is normal based on the total value of the pixels that have been determined as failing and the passing threshold value.

If there are a plurality of defects on a page, an inspection level is set for each defect to determine whether or not it passes. The additional processing is repeated while changing (lowering) the inspection level until a pass level at which all defect locations in the scanned image or on the page are determined as normal. In this case, the inspection may be performed by changing the inspection level one level at a time, or a plurality of inspection levels may be inspected at once. However, this additional processing is performed in the background so as not to degrade the performance of the inspection apparatus 110. If there is no influence on performance, it is also possible to determine whether or not the scanned image is normal at a plurality of (all) inspection levels from the beginning, and to determine the pass level at which the scanned image is determined as normal. The additional processing is not limited to the above method, and may be performed using any other method that is optimal for the inspection apparatus 110 in consideration of processing costs, memory costs, and the like. The pass level determined in the additional processing is stored in the RAM 303.

After the above-described inspection of the printed image is complete, the inspection apparatus 110 causes the CPU 302 to instruct the UI unit 320 to display the inspection results stored in the RAM 303. By displaying the inspection results on the UI unit 320, the operator can easily recognize the inspection results.

In addition, when printed material with a defect occurs, or when a certain number of consecutive printed materials with defects occur, the inspection apparatus 110 causes the CPU 302 to transmit the above information to the image forming apparatus 100 via the communication I/F unit 301.

Information from the inspection apparatus 110 indicating that printed material with a defect has occurred is received by the controller 200 of the image forming apparatus 100 via the communication I/F unit 207 of the image forming apparatus 100. When the controller 200 receives the above information, the CPU 202 of the image forming apparatus instructs the printer unit 210 to stop printing. When the printer unit 210 is instructed to stop printing, the image forming apparatus 100 stops the printing operation.

Furthermore, the inspection apparatus 110 causes the CPU 302 to transmit information to the finisher 120 as well via the communication I/F unit 301 based on the inspection results stored in the RAM 303. The information transmitted to the finisher 120 is information regarding whether or not there is a defect in the printed material. Using the received information, the finisher 120 discharges printed material that is free of defects onto a normal discharge tray, and discharges printed material that has a defect onto an escape tray that is different from the normal discharge tray.

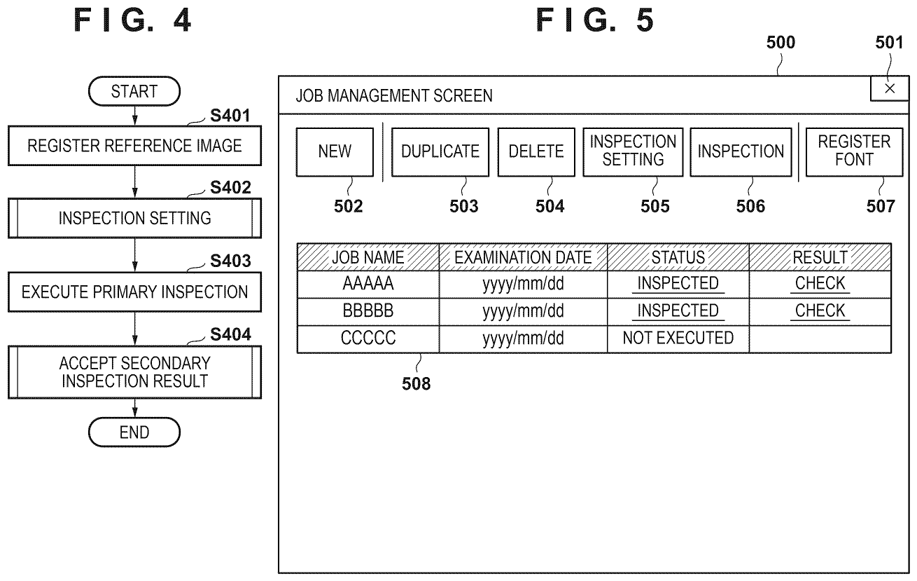

Next, the overall flow from the registration of a reference image before the start of inspection in the inspection apparatus 110, through the primary inspection, to the execution of the secondary inspection will be described with reference to the flowchart of FIG. 4.

The primary inspection is inspection in which the printed material is read after printing and it is automatically determined whether the printed material is an acceptable product or an unacceptable product using a pre-set inspection level. The secondary inspection is inspection in which an operator visually determines whether the printed material is an acceptable product or an unacceptable product for the purpose of sampling inspection of acceptable products or re-inspecting unacceptable products.

Here, an example will be described in which a pass level for facilitating the secondary inspection, which is a feature of one or more embodiments, is presented during the primary inspection.

FIG. 4 is a flowchart for describing the inspection processing performed by the inspection apparatus 110 according to one or more embodiments. Note that the processing shown in this flowchart is realized by the CPU 302 of the inspection apparatus 110 deploying a program code stored in the ROM 304 to the RAM 303, and reading and executing the deployed program code.

First, in step S401, the CPU 302 registers a reference image that is to be a correct answer image for the inspection. At this time, the inspection apparatus 110 waits in a reference image reading mode, and executes a print job for registering the reference image from the client PC 130. As a result, printing is executed by the image forming apparatus 100 based on the print job, and the printed material is transported. Upon detecting the transport of the printed material, the inspection apparatus 110 scans the printed material with the image reading unit 310 and stores the scanned image in the RAM 303 of the inspection apparatus 110 as a reference image. Note that in one or more embodiments, the reference image is registered by being scanned with the image reading unit 310, but there is no limitation to this. For example, a method may be used in which the image data subjected to RIP processing by the print server 140 or the image processing unit 205 of the image forming apparatus 100 is received and registered as a reference image.

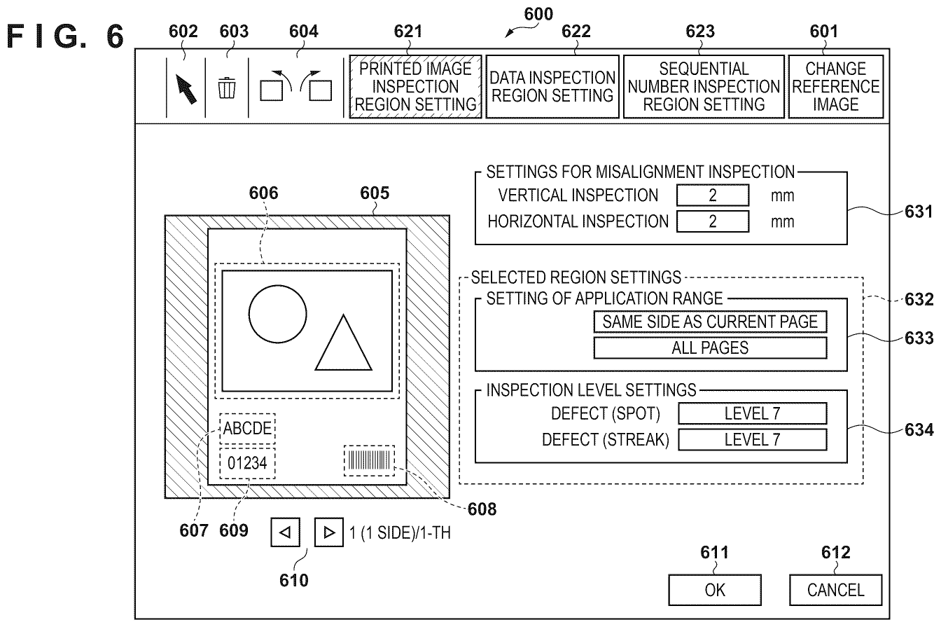

Next, the processing advances to step S402, and the CPU 302 receives inspection settings from the operator and stores various inspection setting values such as the inspection region and the inspection level in the RAM 303 of the inspection apparatus 110. Note that the inspection settings will be described in detail later with reference to FIG. 6.

Next, the processing advances to step S403, and when the CPU 302 receives a print job for inspection from the client PC 130, printing is executed in the image forming apparatus 100 based on the print job for inspection, and the printed material is transported. When transport of the printed material is detected, the printed material is scanned by the image reading unit 310, the scanned image is stored in the RAM 303 of the inspection apparatus 110, and the primary inspection is carried out. At this time, the CPU 302 reads out the stored scanned image and the reference image registered in step S401 from the RAM 303 of the inspection apparatus 110, and performs printed image inspection using the inspection setting values set in step S402. Thereafter, the CPU 302 stores the inspection results in the RAM 303 of the inspection apparatus 110. Furthermore, the CPU 302 also determines the pass level during the printed image inspection by executing the additional processing described above, and stores the determination results in the RAM 303 of the inspection apparatus 110.

Next, the processing advances to step S404, and the CPU 302 receives the results of the secondary inspection from the operator and stores them in the RAM 303 of the inspection apparatus 110. Note that details of step S404 in one or more embodiments will be described later. This ends the processing of this flowchart.

FIG. 5 depicts a view showing an example of a job management screen 500 displayed on the UI unit 320 of the inspection apparatus 110 according to one or more embodiments.

The job management screen 500 is displayed when the inspection apparatus 110 is started up, or when an application is started up from the UI unit 320 by an operation performed by the operator. From this job management screen 500, it is possible to transition to each of the processes of font registration, reference image registration, inspection setting, and inspection processing.

A button 501 is a button for closing the display of the job management screen 500. A new button 502 is a button for creating a new inspection job, and instructs the registration of a reference image. A duplicate button 503 is a button for duplicating an inspection job that has already been created. When the duplicate button 503 is pressed, an inspection job selected in an inspection job list 508 is duplicated. By using inspection job duplication in this manner, it is possible to perform a new inspection job with the reference image and inspection settings duplicated. When the duplicate button 503 is pressed, the inspection setting screen shown in FIG. 6 is transitioned to.

A delete button 504 deletes the inspection job selected in the inspection job list 508. Here, it is also possible to delete multiple inspection jobs at once by selecting multiple inspection jobs and pressing the delete button 504.

An inspection setting button 505 is a button for performing the inspection setting of an inspection job for which registration of a reference image has been completed. An inspection button 506 instructs execution of an inspection job for which registration of a reference image and inspection settings have been completed. A font registration button 507 is used to register a character font.

Next, the inspection setting will be described with reference to FIG. 6.

FIG. 6 depicts a view showing an example of an inspection setting screen 600 for performing inspection setting, and which is displayed on the UI unit 320 of the inspection apparatus 110 according to one or more embodiments. FIG. 6 shows a case where a printed image inspection region setting button 621 is selected, and is an example of a setting screen for printed image inspection. Note that when the inspection setting button 505 in FIG. 5 is pressed, an inspection setting screen in which the display contents of a region 605, settings 631 and 632, and the like on the screen in FIG. 6 are different but displayed contents are basically the same as those in FIG. 6 is displayed.

A reference image change button 601 is a button used when changing the reference image. A button 602 is an inspection region selection button that is pressed by the operator when selection of any one of inspection regions that have already been set is desired. A button 603 is an inspection region deletion button that is pressed by the operator when deletion of a selected inspection region is desired. A button 604 is a button for rotating the image displayed in the region 605.

The region 605 is a display region for displaying the inspection region of the loaded reference image and the like. When there are a plurality of sheets to be read and the corresponding plurality of reference images, the image to be displayed is switched using a button 610. In addition, the front and back of the loaded sheet can be switched by pressing the button 610. Specifically, each time the right arrow button 610 is pressed, the pages switch in the following order: the front of a first sheet, the back of the first sheet, the front of a second sheet, and the back of the second sheet. An OK button 611 is an OK button for storing the settings on the inspection setting screen 600 and transitioning to the job management screen 500 shown in FIG. 5. Also, by pressing the OK button 611, an inspection screen (not shown) may be transitioned to and inspection may be performed. A cancel button 612 is a cancel button for transitioning to the job management screen 500 in FIG. 5 without storing the settings on the inspection setting screen 600.

The printed image inspection region setting button 621 is a button that is pressed by the operator when setting a new printed image inspection region. After pressing this button 621, the operator can set an inspection region for the reference image displayed in the region 605. A region 606 shows an example of a setting of a printed image inspection region.

A data inspection region setting button 622 is pressed by the operator when setting a new region for character inspection or barcode inspection. After pressing the button 622, the operator sets a target inspection region on the reference image displayed in the region 605. A character region 607 in the region 605 shows an example of a setting of a character inspection region. Also, a region 608 in the region 605 shows an example of a setting of a barcode inspection region. A region 609 shows an example of a setting of a sequential number inspection region such as a page number.

In FIG. 6, the region 606, the character region 607, the region 608, and the region 609 are depicted in the same black dotted frame, but each region may also be displayed so as to be identifiable as a region in which different processing is performed. For example, the borders of the regions in which different processing is performed may be displayed in different colors, and/or several types of broken lines, or the like. Also, the display color of these frames may be made selectable by the operator.

A sequential number inspection region setting button 623 is pressed by the operator when setting a new sequential number inspection region. After pressing the button 623, the operator sets a sequential number inspection region, for example, as indicated by the region 609, in the reference image displayed in the region 605. Sequential number inspection is data inspection performed based on a predetermined rule. The predetermined rule includes a start number, an end number, an increment or decrement value, and the like.

A misalignment inspection setting 631 is a setting for misalignment inspection, and sets an allowable amount of misalignment of the print position from the reference image. FIG. 6 shows an example in which the operator has designated that a misalignment amount of 2 mm or more in the vertical and horizontal directions is to be detected. That is, the value designated by the operator here corresponds to a threshold value in detecting misalignment. If a deviation greater than or equal to the threshold value set here is detected, the inspection is determined as NG.

Selected region settings 632 are a group of UIs for making settings for the region currently selected in the region 605. An application range setting 633 sets the application range of the selected region. If nothing is selected, the selected inspection region will be placed only on the page currently displayed in the region 605. If “same side as current page” is selected, the selected inspection region is disposed on pages of the same side depending on whether the selected inspection region is disposed on the front side or back side of the sheet. If “all pages” is selected, the selected inspection region is disposed on all pages.

An inspection level setting 634 is a setting of an inspection level for an inspection item such as a circular defect (spot) or a linear defect (streak), and the inspection level is set for each item. The inspection level is a parameter that is set in levels to determine how large a defect must be to be determined as a defect for each feature of the detected defect. For example, there are nine levels, from level 1 to level 9, and thinner and smaller defects can be detected in level 9 as compared to level 1. That is, defects are detected more strictly in level 9 as compared to level 1. It is also possible to set different inspection levels for the respective inspection items, for example, inspection level 5 for spots and inspection level 4 for streaks. In the inspection level setting 634 in FIG. 6, an example is shown in which the inspection level setting for a defect (spot) is set to level 7, and the inspection level setting for a defect (streak) is set to level 7 by the operator.

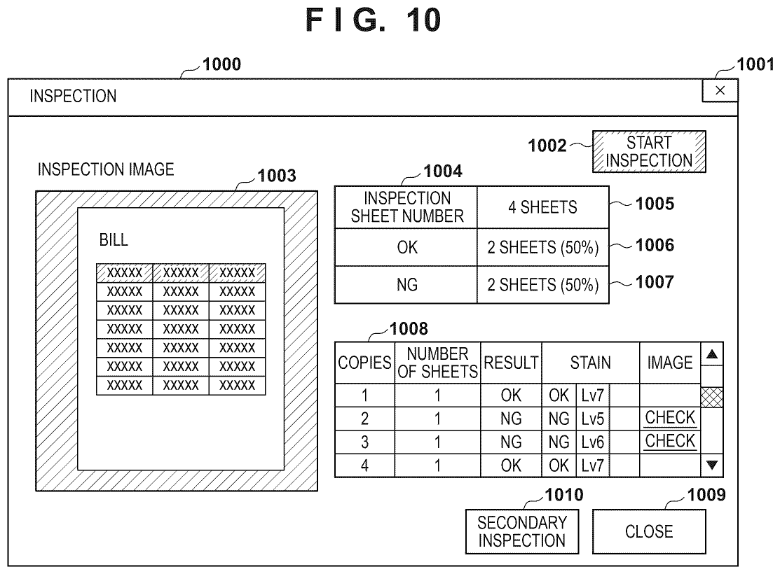

Next, the inspection screen will be described with reference to FIG. 10.

FIG. 10 depicts a view showing an example of an inspection screen 1000 displayed on the UI unit 320 of the inspection apparatus 110 in one or more embodiments.

This inspection screen 1000 shows a state after the primary inspection has been performed. A button 1001 is a button for closing the display of the inspection screen 1000. When the button 1001 is pressed, the job management screen 500 shown in FIG. 5 is transitioned to.

An inspection start button 1002 is a button for instructing the start of reading of an inspection sheet (printed material). After inspection is executed, the inspection start button 1002 is grayed out. A region 1003 is a region for displaying an image of the inspection sheet, and nothing is displayed before the start of inspection. A region 1004 is a region for displaying the number of inspected sheets, and the number is 0 before the start of inspection. In an inspection sheet number region 1005, the total number of inspected sheets is displayed. In an OK sheet number region 1006, the total number of sheets for which the inspection result is OK (passing) and the OK rate are displayed. In an NG sheet number region 1007, the total number of sheets for which the inspection result is NG (failed) and the NG rate are displayed. That is, the total of the numbers in the OK sheet number region 1006 and the NG sheet number region 1007 is the numerical value in the inspection sheet number region 1005. The sum of the OK rate and the NG rate is 100%. In the example of FIG. 10, a total of four sheets were inspected, two of which were OK and two of which were NG.

In region 1008, the inspection result for each side of the inspection sheet is displayed. Details of the inspection results displayed in the region 1008 will be described below with reference to FIGS. 8A to 8C.

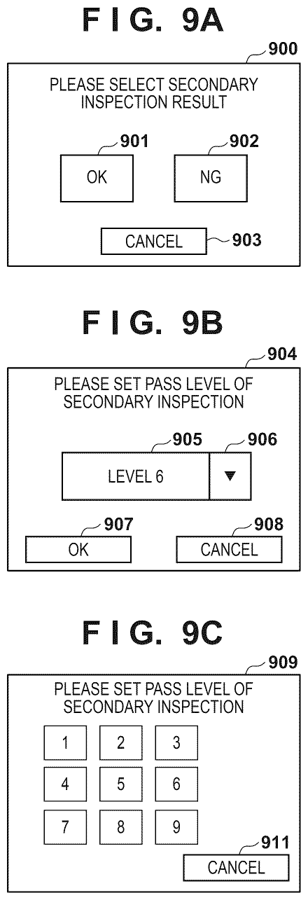

A close button 1009 is a button for storing the inspection results and ending the inspection. When the close button 1009 is pressed, the job management screen 500 shown in FIG. 5 is transitioned to. A secondary inspection button 1010 is a button for inputting the results of secondary inspection. When the secondary inspection button 1010 is pressed, an input screen for the secondary inspection results shown in FIG. 9B is transitioned to. This will be described in detail later in one or more embodiments below.

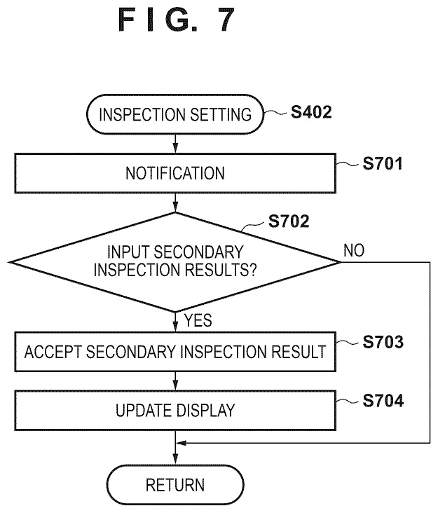

FIG. 7 is a flowchart for describing inspection setting processing in step S404 of FIG. 4. Secondary inspection will be described below with reference to the flowchart in FIG. 7, the inspection result details screens in FIGS. 8A to 8C, and the secondary inspection result input screens in FIGS. 9A to 9C.

FIGS. 8A to 8C are diagrams illustrating details of the inspection result in the region 1008 of FIG. 10 displayed on the UI unit 320 of the inspection apparatus 110 according to one or more embodiments.

FIG. 8A shows detailed inspection results displayed in the region 1008 of the inspection screen 1000 after the primary inspection is performed in step S403. Here, an example will be described in which four copies are output and inspected using a print job for printing one single-sided page on a sheet of paper. The inspection settings for printed image inspection are shown assuming that all inspection levels are set to level 7, with a passing inspection result being OK and a failed inspection result being NG.

An item 801 indicates the number of copies to be output, and an item 802 indicates the number of pages (number of sheets). An item 803 indicates the determination result of the primary inspection in step S403, that is, the result of the primary inspection. An item 804 indicates the spot inspection result in the printed image inspection. This item 804 includes the primary inspection result 805, the pass level 806, and a secondary inspection result 807. In the item 804, an input button (object) is displayed in association with the secondary inspection result 807 only when the primary inspection result 805 is NG.

An item 808 shows the streak inspection result in the printed image inspection, and the configuration of the item 808 is the same as that of the item 804. However, for the item 808, the primary inspection results are OK for all four copies, and therefore no input button (object) is displayed for the secondary inspection results.

An item 809 indicates the inspection results of data inspection. The results of data inspection are simply displayed as OK or NG, but the results of the read character string or barcode and correct answer data information may also be displayed. In an item 810, a confirmation button is displayed to instruct confirmation of the inspected scanned image if the determination result of the primary inspection of the item 803 is NG. When the confirmation button of the item 810 is pressed, the scanned image determined as NG (NG details screen (not shown)) is displayed. This NG details screen displays a scanned image in which the defect locations determined as spots or streaks are marked, an enlarged image of the defect locations, detailed information about the defect, and the like. Note that if there are other inspection items besides spots, streaks, and data, a column corresponding to each inspection item is added in a similar manner.

An inspection result 811 denotes the inspection results of the first copy of the job, and in this example, all inspection items are OK, and therefore the primary inspection result of the item 803 is OK. Also, the pass level 806 is at inspection setting level 7.

An inspection result 812 denotes the inspection results of the second copy of the job, and since spot determination in the primary inspection is NG, the primary inspection result of the item 803 is NG. As a result of the additional processing described above, when a spot is determined as passing, the pass level 806 is level 5.

An inspection result 813 denotes the inspection results of the third copy of the job, and since the result of the spot determination in the primary inspection is NG, the primary inspection result of the item 803 is NG. As a result of the additional processing described above, when a spot is determined as passing, the pass level 806 is level 6.

If the secondary inspection is performed on the inspection result 812 and the inspection result 813 in this way, the operator presses the input button for the secondary inspection result 807 corresponding to each inspection result. As a result, an input screen 900 shown in FIG. 9A is displayed on the UI unit 320. This allows the operator to carry out the secondary inspection and input whether or not the inspection result is OK. The input screen 900 is a screen for inputting the determination result of the secondary inspection, and has an OK button 901, an NG button 902, and a cancel button 903. The operator can input whether the result of the secondary inspection was pass (OK) or fail (NG) via this input screen 900.

FIGS. 9A to 9C depict views respectively showing examples of input screens for the secondary inspection result displayed on the UI unit 320 of the inspection apparatus 110 according to one or more embodiments.

Next, a description will be given with reference to the flowchart of FIG. 7 and FIGS. 9A to 9C. Note that the processing shown in the flowchart of FIG. 7 is realized by the CPU 302 of the inspection apparatus 110 deploying program code stored in the ROM 304 to the RAM 303, and reading out and executing the deployed program code.

In step S701, the CPU 302 receives notification of a UI operation performed by the operator from the UI unit 320. Next, in step S702, the CPU 302 determines whether or not the input button for the secondary inspection result 807 in FIG. 8A has been pressed. If the input button has been pressed, the processing advances to step S703, and if an operation other than pressing the input button is performed, the processing ends. In step S703, the CPU 302 displays the input screen 900 shown in FIG. 9A, for example, on the UI unit 320.

Then, in step S703, when the CPU 302 receives input from the operator via the input screen 900, the CPU 302 stores information based on the input in the RAM 303. For example, if the NG button 902 in FIG. 9A is pressed for a determination result of NG for spots in the inspection result 812, NG is stored as the secondary inspection result for spots in the inspection result 812. If the OK button 901 in FIG. 9A is pressed for a determination result of NG for spots in the inspection result 813, OK is stored as the secondary inspection result for spots in the inspection result 813. If the cancel button 903 is pressed, the inspection result is not stored. An example of this case is shown in FIG. 8B.

The processing then advances to step S704, and the CPU 302 displays the updated inspection screen 1000 on the UI unit 320. The update of the display of the inspection screen 1000 will be described using FIG. 8B as an example.

FIG. 8B shows only the items 801 to 804 of FIG. 8A, and shows the state in which the secondary inspection results of the inspection result 812 and the inspection result 813 have been input as described above. If the secondary inspection result for spots in the inspection result 812 is NG, NG is displayed instead of the input button in the secondary inspection result 807 in the inspection result 812. If the secondary inspection result for spots in the inspection result 813 is OK, OK is displayed instead of an input button in the secondary inspection result 807 in the inspection result 813. Furthermore, in the inspection result 813, since the inspection result for spots is OK, the inspection results for all inspection items are also OK, and therefore the primary inspection result of the item 803 is displayed as OK instead of NG. When the display of the primary inspection result changes in this way, the change may be made easier to recognize by coloring or shading the display, or the like.

Alternatively, as shown in FIG. 8C, a secondary inspection result column 814 displaying the secondary inspection result may also be prepared. The display of the region 1008 in FIG. 10 is updated in this manner.

To describe the above example in more detail, the second copy of one single-sided page corresponding to the inspection result 812 is determined as passing primary inspection by lowering the inspection level to level 5. However, in the secondary inspection, the operator determines that the second copy of one single-sided page fails. On the other hand, the third copy of one single-sided page corresponding to the inspection result 813, is determined as passing the primary inspection by lowering the inspection level to level 6. In the secondary inspection, the operator determines that the third copy of one single-sided page is equivalent to passing. That is, if it is determined that the printed material passes when the inspection level is level 6, the operator has determined that the printed material is equivalent to passing.

In this case, furthermore, since the primary inspection result of the inspection result 813 has changed from NG to OK, the display of the region 1004 in FIG. 10 is also updated. That is, the OK sheet number region 1006 changes from 2 (50%) to 3 (75%), and the NG sheet number region 1007 changes from 2 (50%) to 1 (25%). The display of the inspection screen 1000 is updated every time the secondary inspection result 807 is input.

The method of inputting the secondary inspection result 807 has been described using the input screen 900 in FIG. 9A, but the secondary inspection result 807 can be easily corrected by displaying a pull-down button instead of an input button and allowing the user to select OK or NG. By providing a blank space in addition to OK and NG as options for the pull-down button, it is possible to cancel the input of the secondary inspection result 807 as well. Note that the secondary inspection result 807 input using the input screen 900 can also be corrected by returning to step S702. In this case, in step S702, it is determined whether or not the input button or a correction button (not shown) has been pressed.

After completing input of the secondary inspection results, the operator presses the button 1001 or the close button 1009 in FIG. 10, thereby transitioning from the inspection screen 1000 to the job management screen 500. At this time, the CPU 302 may determine whether or not all of the secondary inspection results have been input, and if not, the CPU 302 may give a warning on a UI (not shown) to the effect that the secondary inspection results have not been input.

As described above, according to one or more embodiments, for items that failed primary inspection, the operator can determine whether they pass or fail based on the pass level at which passing is determined, and this can be indicated as the result of the secondary inspection. This makes it possible to reduce the amount of time required for an operator to visually perform the secondary inspection and to reduce the variation in the determination made in the secondary inspection.

In one or more embodiments, an inspection level may be adjusted after it is determined (e.g., automatically by one or more processors, manually by one or more inspectors/operators, etc.) to be too strict or limited.

In one or more of the above-described embodiments, an example has been described in which the operator inputs the result of secondary inspection for each inspection item that has failed the primary inspection. However, if the operator determines that the inspection level that was initially set was too strict, all products that have reached a certain initial inspection level may be changed to acceptable products that comply with the adjusted inspection level. In addition, printed material that has failed the secondary inspection may be reprinted and reevaluated, and it is desirable that the inspection level at that time is the inspection level at which the printed material passed the secondary inspection.

In view of this, in one or more embodiments, taking the above-described changes or adjustments into consideration, a method will be described in which inspection results of the secondary inspection are collectively input, and when reprinting, inspection is performed at the inspection level at which the printed material passed the secondary inspection, thereby further reducing the burden on the operator. Hereinafter, one or more embodiments will be described below with reference to any differences, modifications, or variations from the above-described features of one or more embodiments. Note that the parts not described in detail are the same as those in the above-described one or more embodiments.

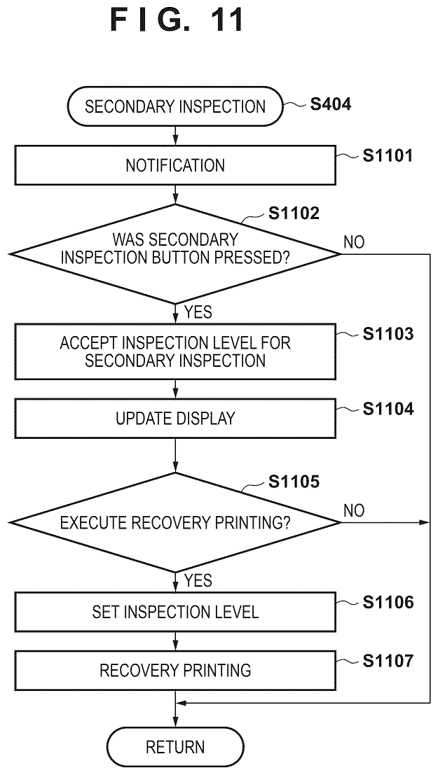

FIG. 11 is a flowchart for describing the secondary inspection processing in step S404 that may be performed by the inspection apparatus 110 according to one or more embodiments of the present disclosure. The processing shown in this flowchart is realized by the CPU 302 of the inspection apparatus 110 deploying a program code stored in the ROM 304 to the RAM 303, and reading out and executing the program code deployed to the RAM 303.

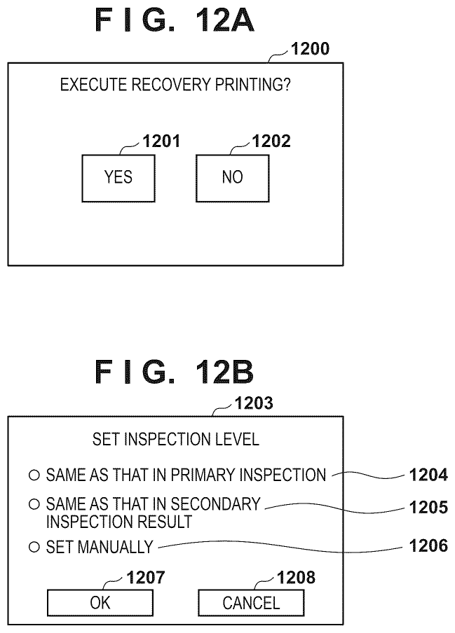

Input of the secondary inspection result will be described with reference to the flowchart in FIG. 11, the input screens of the results of the secondary inspection in FIGS. 9B and 9C, and the recovery print screens in FIGS. 12A and 12B.

In step S1101, the CPU 302 receives notification of a UI operation performed by the operator from the UI unit 320. Next, the processing advances to step S1102, and the CPU 302 determines whether or not the secondary inspection button 1010 on the inspection result screen 1000 in FIG. 10 has been pressed. If it is determined that the secondary inspection button 1010 has been pressed, the processing advances to step S1103, and if it is determined that an operation other than pressing the secondary inspection button 1010 has been performed, this processing ends.

In step S1103, the CPU 302 displays the input screen 904 of FIG. 9B on the UI unit 320. This input screen 904 is a screen for inputting the inspection level for the secondary inspection. A button 906 is a pull-down button, and when the button 906 is pressed, a level (numeric value) that can be set as the inspection level can be selected. A region 905 is a region where the inspection level selected with the button 906 is displayed, and initially, the inspection level set in the inspection level setting 634 in FIG. 6 (level 7 in this embodiment) is displayed. The input screen 904 further includes an OK button 907 and a cancel button 908. Although only one region 905 and one button 906 are displayed, a plurality thereof may be included such that, for example, an inspection level can be set for each of the inspection items, namely, spots and streaks. Here, description will be given assuming that the same setting can be made for a plurality of inspection items. In the region 905 in FIG. 9B, the initial inspection level 7 is lowered by one inspection level to level 6.

In step S1103, the CPU 302 receives the inspection level input on the input screen 904 and stores the result in the RAM 303. Here, unlike one or more embodiments discussed above, the pass level permitted in the secondary inspection result may be the inspection level input on the input screen 904, which is stored in the RAM 303. In this case, for example, after performing the primary inspection in step S403 at inspection level 7, the operator visually checks, in the secondary inspection, the printed material that has failed the primary inspection. If the pass level 806 when the secondary inspection is determined as passing is level 6, the operator selects level 6 on the input screen 904 with the button 906. In this way, when the OK button 907 is pressed with level 6 selected, level 6 is set and stored as the pass level permitted as the secondary inspection result. If the cancel button 908 is pressed, the pass level permitted as the secondary inspection result is not stored.

Note that the method of inputting the inspection level is not limited to a pull-down method, and for example, as shown in the input screen 909 in FIG. 9C, an inspection level (level 1 to level 9) that can be set as appropriate may be displayed using number buttons and set. A cancel button 911 cancels setting values in the input screen 909 to return the previous screen.

In addition, as an option for the inspection level, it may be possible to disable setting of an inspection level stricter than the inspection level set for the primary inspection (larger than the primary inspection level) or an inspection level that is significantly different from the inspection level set for the primary inspection. Also, if an inspection level that cannot be set is selected, a warning may be issued. Also, the selectable levels may be restricted or the like depending on the skill level of a user who is logged in as the operator.

The processing then advances to step S1104, and the CPU 302 displays the updated inspection screen 1000 on the UI unit 320. At this time, the CPU 302 reads out the inspection results after the primary inspection and the pass level (level 6) permitted as the secondary inspection result stored in step S1103. Then, the secondary inspection results for all items for which the pass level 806 is level 6 after the primary inspection are stored as OK. On the other hand, the secondary inspection results of all items for which the pass level 806 is lower than level 6 are stored as NG. Thereafter, similarly to step S704, the display of the secondary inspection results 807, the item 803 indicating the primary inspection results, the OK sheet number region 1006, and the NG sheet number region 1007 is updated. Here, a configuration may be used in which, after updating the inspection results collectively, additional input of an individual inspection result is performed as described in one or more embodiments.

Next, the processing advances to step S1105, where the CPU 302 determines whether or not recovery printing is to be executed. Recovery printing refers to re-printing printed material for which the result of the secondary inspection is NG so that the re-printed material may be inspected or re-inspected. The CPU 302 displays a confirmation screen 1200 shown in FIG. 12A on the UI unit 320 to confirm whether or not recovery printing is to be executed, and if a Yes button 1201 is pressed (YES in step S1105), the processing advances to step S1106. If a No button 1202 is pressed (NO in step S1105), the processing shown in this flowchart ends.

FIGS. 12A and 12B depict views showing examples of screens for instructing inspection through recovery printing, which are displayed on the UI unit 320 of the inspection apparatus 110 according to one or more embodiments.

In step S1106, the CPU 302 displays, on the UI unit 320, a setting screen 1203 in FIG. 12B for receiving the setting of the inspection level for recovery printing, and stores the inspection level selected on this setting screen 1203 in the RAM 303. An item 1204 is an item for selecting the same inspection level as the primary inspection, an item 1205 is an item for selecting the same inspection level as the secondary inspection result, and an item 1206 is an item for selecting manual setting of the inspection level. The items 1204 to 1206 are radio buttons, and only one of them can be selected.

If an OK button 1207 is pressed while the item 1204 is selected, in the above example, the inspection level for recovery printing is stored as level 7, which is the same as in the primary inspection, and the inspection screen 1000 is transitioned to.

Also, if the OK button 1207 is pressed while the item 1205 is selected, in the above example, the level 6 used in the secondary inspection is stored as the inspection level during recovery printing, and the inspection screen 1000 is transitioned to.

Also, when the OK button 1207 is pressed while an item 1206 is selected, the setting screen 1203 is closed and the inspection setting screen 600 in FIG. 6 is transitioned to. When the inspection level is set on the inspection setting screen 600 and the OK button 611 is pressed, the inspection level for recovery printing is set and the job management screen 500 is transitioned to. A cancel button 1208 is a button for discarding the settings on this setting screen 1203 and transitioning to the original screen.

In step S1107, if the CPU 302 determines that the inspection start button 1002 on the inspection screen 1000 or the inspection button 506 on the job management screen 500 in FIG. 5 has been pressed, recovery printing is executed, and recovery printing at the inspection level stored in step S1106 is executed. This concludes the description of the flowchart in FIG. 11.

In addition, after the recovery printing, the operator must return the recovery-printed printed material to the correct position within the large amount of the printed material. However, when a plurality of copies of one page of printed material are printed, there is no problem in the final product even if the recovery-printed printed material is returned to the beginning or end of the printed materials that have passed the primary inspection. However, doing so is problematic in that the number of pages output in the inspection result log will differ from the number of pages in the final product. For this reason, when outputting the inspection result log, the result of a page that failed the primary inspection can be moved to the beginning or end of the log to match the order of the final product with the order of the log, thereby further reducing the workload of the operator. Note that the operator can set in advance whether the result of a page that has failed the primary inspection is to be moved to the beginning or end. Thus ends the description of the method of inputting secondary inspection results and recovery printing in one or more embodiments.

As described above, according to one or more embodiments, it is possible to input the secondary inspection results collectively and further perform reprinting with fewer steps. This makes it possible to significantly reduce the amount of time required for the secondary inspection, the variation in the determination made during the secondary inspection, and the workload of the operator.

In the above-described embodiment, for example, if there is a large discrepancy between the inspection level set on the inspection setting screen 600 in FIG. 6 and the inspection level at which passing is determined in the additional processing, it may be possible to disable correction of the result of the primary inspection from NG to OK, as shown in FIG. 8B. Alternatively, a warning may be issued to the effect that the results of the primary inspection cannot be corrected. Alternatively, it may be possible to display whether or not the results of the primary inspection can be corrected depending on the operator's ability, qualifications, and the like.

In addition, in the case of a 1 to N print (1-n print) job, it is conceivable that images that are determined as NG in the secondary inspection are moved to the end (or beginning) of the job, and therefore it is desirable to make the number of pages in the inspection log changeable.

It is also desirable that a summary page of the inspection log displays the number of pages that were determined as OK in the primary inspection, in addition to the number of pages that were determined as OK after the secondary inspection.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes one or more embodiments, it is to be understood that the scope of the present disclosure is not limited to the disclosed embodiments. The scope of the following claims is to be accorded the broadest interpretation so as to encompass all such modifications, equivalent structures, and functions.

This application claims the benefit of Japanese Patent Application No. 2024-005560, filed Jan. 17, 2024, which is hereby incorporated by reference herein in their entirety.

What is claimed is:

1. An inspection apparatus that operates or is configured to inspect printed material, the inspection apparatus comprising:
one or more controllers including one or more processors in communication with one or more memories, the one or more controllers configured or operating to:
obtain a scanned image generated by reading the printed material;
set an inspection level for determining whether the printed material passes or fails in a primary inspection;
compare the scanned image with a reference image and inspect the printed material based on the set inspection level; and
display a screen showing an inspection result of the primary inspection on a display,
wherein the screen includes the inspection result of the primary inspection for the printed material at the set inspection level, an object that is associated with the inspection result and indicates a target for inputting a result of a secondary inspection, and a pass level at which an inspection result of the printed material is that the printed material passes the primary inspection.

2. The inspection apparatus according to claim 1,
wherein the target for inputting the result of the secondary inspection is printed material for which the inspection result of the printed material at the set inspection level is that the printed material has failed the primary inspection.

3. The inspection apparatus according to claim 2,
wherein the object is displayed in association with the inspection result of the printed material that failed the primary inspection at the set inspection level.

4. The inspection apparatus according to claim 1,
wherein in a case where the screen is displayed, the one or more controllers cause the display to display a screen for inputting a result of the secondary inspection due to the object being instructed.

5. The inspection apparatus according to claim 1,
wherein in the setting of the inspection level, the one or more controllers further operate to set an inspection region and an inspection item to be targets of the primary inspection, and are able to set the inspection level for each of the inspection items.

6. The inspection apparatus according to claim 1,
wherein in the primary inspection of the printed material, in a case where the inspection result of the printed material at the set inspection level is that the printed material has failed the primary inspection, the one or more controllers further operate to repeatedly execute the primary inspection of the printed material while changing the inspection level until the inspection result of the printed material is that the printed material passes the primary inspection, and the inspection level at which the inspection result of the printed material is that the printed material passes the primary inspection is set as the pass level.

7. The inspection apparatus according to claim 1,
wherein the secondary inspection is a visual inspection of the printed material performed by an operator, or the one or more controllers further operate to perform the secondary inspection such that: (i) the printed material is displayed on the display for visual inspection of the printed material and (ii) the one or more controllers further operate to receive an input as to whether the displayed printed material passed the secondary inspection or not.

8. The inspection apparatus according to claim 1,
wherein when displaying the screen, the one or more controllers further operate to cause the display to display a screen in which an inspection result of the printed material has been updated based on the result of the secondary inspection.

9. The inspection apparatus according to claim 8,
wherein the inspection result is updated by collectively updating all inspection items for which the printed material was determined as having failed the primary inspection at the set inspection level and for which the printed material was determined as passing at the pass level in the primary inspection.

10. The inspection apparatus according to claim 1,
wherein in a case where the printed material determined as passing at the pass level is determined as passing in the secondary inspection, the one or more controllers further operate to enable setting of an inspection level in the secondary inspection based on the pass level.

11. The inspection apparatus according to claim 1,
wherein the one or more controllers further operate to instruct recovery printing or re-printing of an image of the printed material determined as failing through the secondary inspection and re-inspection of the image of the printed material printed through the re-printing.

12. The inspection apparatus according to claim 11,
wherein the one or more controllers further operate to set the inspection level in the re-inspection.

13. The inspection apparatus according to claim 12,
wherein the set inspection level in the re-inspection is one of: a same inspection level as the level used in the primary inspection, a same inspection level as the level used in the secondary inspection, or any inspection level that is set manually.

14. The inspection apparatus according to claim 1,
wherein in a case of outputting a log of the inspection result of the inspected printed material, the one or more controllers further operate to move the inspection result of the printed material that failed the primary inspection at the set inspection level to the beginning or end of the log.

15. A method of controlling an inspection apparatus that operates or is configured to inspect printed material, the method comprising:
obtaining a scanned image generated by reading the printed material;
setting an inspection level for determining whether the printed material passes or fails in a primary inspection;
comparing the scanned image with a reference image and inspecting the printed material based on the set inspection level; and
displaying, on a display, a screen showing an inspection result of the primary inspection obtained by inspecting the printed material,
wherein the screen includes the inspection result of the primary inspection for the printed material at the set inspection level, an object that is associated with the inspection result and indicates a target for inputting a result of a secondary inspection, and a pass level at which an inspection result of the printed material is that the printed material passes the primary inspection.

16. An inspection system comprising:
a printing apparatus that operates or is configured to perform printing based on a job; and
an inspection apparatus having:
one or more controllers including one or more processors in communication with one or more memories, the one or more controllers configured or operating to:
obtain a scanned image generated by reading a printed material that is printed by the printing apparatus;
set an inspection level for determining whether the printed material passes or fails in a primary inspection;
compare the scanned image with a reference image and inspect the printed material based on the set inspection level; and
display a screen showing an inspection result of the primary inspection on a display,
wherein the screen includes the inspection result of the primary inspection for the printed material at the set inspection level, an object that is associated with the inspection result and indicates a target for inputting a result of a secondary inspection, and a pass level at which an inspection result of the printed material is that the printed material passes the primary inspection.
